(19) United States
(12) Patent Application Publication
(10) Pub. No.: US 2005/0251499 A1
(43) Pub. Date: Nov. 10, 2005

(54) Method and system for searching documents using readers valuation

(76) Inventor: Zezhen Huang, Canton, MA (US)

Correspondence Address: Zezhen Huang, 5 Beaver Brook Road, Canton, MA, 02021, US

(21) Appl. No.: 11/121,458

(22) Filed: May 2, 2005

Related U.S. Application Data
(60) Provisional application No. 60/567,658, filed on May 4, 2004.

(51) Int. Cl. G06F 7/00

(52) U.S. Cl. 707/1

(57) ABSTRACT

A method and system for ranking pages using valuations from readers is disclosed. A reader's time spent on a page is tracked, normalized on the length of the document, capped to limit the effect of one individual, and a reader valuation score of the page comprising the time is updated. Higher value of reader valuation score of a page represents longer time reader(s) spent on the page and therefore higher value to the reader(s). Pages containing relevant keywords can then be sorted by reader valuation scores. Reader valuation scores of pages can be maintained in a private account to help a reader more effectively organize his or her reading history, or be maintained for public to represent general readers' valuations on pages, or be maintained in groups of readers with attributes such as profession, educational level, age, sex to represent special group of readers' valuations on pages.

### CROSS REFERENCE TO RELATED APPLICATIONS

This application claims the benefit of PPA application No. 60/567,658, filed May 4, 2004 by the present inventor.

### FIELD OF INVENTION

The present invention generally relates to the field of search engine. More specifically, the present invention relates to valuations and sorting of documents.

### INTRODUCTION

A search engine receives key words entered by a user, compiles a list of documents comprising some or all of the key words, sorts the list based on “value” of the documents and returns the list to the user. The sorting of documents, or putting “value” on the document, is the critical part that distinguishes search engines. In the World Wide Web, a document is referred to as a page, and the address to the page is referred to as a link. In this specification, a page refers to an electronic document comprising any format and any content. Typically, Each item returned in the list from the search engine contains a link to a page and a few sentences abstracted from the page to give user some information. The higher order of an item in the list represents higher value or importance of the page, as the user usually starts reading from the top of the list. Therefore for a search list containing hundreds or thousands of documents; putting higher value of documents on top of the list saves user time. Usually, a user looks through the list, click on a link to open and read a page, go back to the list and click on another link and read another page, and so on. A user would spend more time reading a page if it is of more interest to him or her.

One popular search technology is from Google. Google uses a technology referred to as PageRank that relies on the uniquely democratic nature of the web by using its vast link structure as an indicator of an individual page's value. In essence, PageRank interprets a link from page A to page B as a vote, by page A, for page B. PageRank also analyzes the page that casts the vote. Votes cast by pages that are themselves “important” weigh more heavily and help to make other pages “important.” Higher values (more “important”) of pages are then returned in higher order of the list. The “voters” in this technology are indeed the writers of pages, and the valuation on pages represents the opinions of a number of writers who have published documents (pages). The opinions of greater number of people, the readers, however, are not reflected.

One method that has been used to measure readers' interests on a page is to count the number of clicks a page has been visited. There are two drawbacks with counting page clicks: first, it does not know how much interest a reader has on a page after opening it. A reader may follow a link and quickly close it if he or she finds no value; second, it does not know whether it is a user who opens the page or a software agent that automatically opens the page, search engines regularly employ software agents to automatically follow links and open pages for indexing, the software agent's identity can be easily faked and allowing someone to employ software agent to automatically open a page to boost the click counts.

### SUMMARY OF THE INVENTION

This invention is a method and system to enhance existing search technology in sorting documents. It offers a new technique to rank pages using valuation scores from readers. On the Internet, the number of readers is greatly larger than the number of writers. Therefore, valuation from readers can more accurately represent the value of pages. One mean to measure the valuation score from a reader about a page is to track the time the user has spent on reading the page. A reader usually spends more time reading a page if it is of high value to the reader. The longer a user spent on reading the page, the higher valuation score is from that reader. The time spent by all readers on a page is then combined to represent all readers' valuation score on the page. The longer the total time of readers spent on a page, the higher valuation score is for the page and the higher order in the returned list the page could be. To eliminate or reduce certain factors that do not necessarily represent valuation in contributing to the valuation scores, the length of time spent can be normalized on both content length and per user base as will be described below.

The present invention of using reader valuation scores can be applied to individual user, a group of users based on a variety of classifications such as professions or ages, or the general public. When apply to individual user where the valuation scores are obtained from and maintained for the user, the invention helps the user more effectively organize his or her reading history by putting higher values on more important documents that the user have spent more time on. When apply to a group of users where the valuation scores are obtained from the group of users, the invention can sort the documents according to a specific group of users valuations.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 shows a software agent tracking reader's time spent on a document on a computer;

FIG. 2 is a diagram showing document search system operation using reader valuation scores;

For the most part, and as will be apparent when referring to the figures, when an item is used unchanged in more than one figure, it is identified by the same alphanumeric reference indicator in the various figures in which it is presented.

### DETAILED DESCRIPTION OF THE PREFERRED EMBODIMENTS

In one embodiment of the present invention, the search engine maintains a public category of readers' valuation scores on pages. A higher valuation score represents a higher value on a page. In general application, the valuation score can be a normalized length of reader time spent on the page (means of tracking reader time spent will be described later). Normalization will eliminate or reduce certain factors in measuring the score. For example, a page of longer content would take longer to read than a page of shorter content, however, longer content may not necessarily mean higher value. Therefore, using length of time normalized on the content length can eliminate or reduce the effect of content length in measuring the page value. For pages containing text, the normalization could be the length of time spent divided by number of words and timed by a scaling factor. For images, the normalization could be the length of time spent divided by number of images and timed by a scaling factor. Or, an image could be equated with a certain number of words in terms of time consumed. So for pages containing text and images, first convert images to equivalent number of words and count total number of words including text and images, and the normalization could be the length of time spent divided by the total number of words timed by a scaling factor. The normalization can be done on per reader base as well. To limit the effect of one reader on the overall valuation score, the maximum time per reader on a page can be set. Once a reader has reached the maximum time on a page, additional time spent on the page may not be counted. Per user maximum time of a page can be set according to content length. In this public category, each page has a valuation score combined from valuation scores received from all readers. In response to a search, the search engine first compiles a list of pages comprising all or some of the key words entered, then sorts the list of pages in the order of reader valuation scores and return the list to the user.

In another embodiment of the present invention, the search engine maintains a user account for each user and maintains a private category of reader valuation scores on pages. In the private category, each user account maintains valuation scores on pages that are received from the user. In response to a search from a user, the search engine sorts the list of pages in the order of valuation scores in the private category of the user account and return the list to the user. As described in the previous embodiment, a valuation score is the normalized time spent on a page. Using private valuation score puts higher value on pages on which the user had previously spent longer time. It is quite common, especially in the research community, for a user trying to retrieve a page he or she has previously read but forgot where is the link. This embodiment of the present invention helps the user more effectively identify a previous important link. In this embodiment, the search engine can maintain both public category and private category. It is up to the user to choose which category of valuation scores to use for sorting pages. The search engine can also attach valuation scores from public category and private category to each item returned in the list, and the user can re-sort the list as like.

In another embodiment of the present invention, multiple group categories of reader valuation scores can be created. The category could be based on professions, ages, or other classifications. When a user account is created, the user may be asked to reveal his or her profession, age, or other classification information, whose valuation scores on pages are then added to the corresponding category. To protect user privacy, the reader identities may not be maintained in the categories. In response to a search, the search engine may automatically determine which category of valuation scores to use for sorting documents depending on the subject of documents. Or, a user may choose the category to use for sorting. Or, the search engine may attach valuation scores from multiple categories to each item returned in the list, and the user may resort the list using specific category of valuation scores.

In yet another embodiment of the present invention, the valuation scores on pages are weighted combination of reader valuation scores and writer valuation scores. Writer valuation score on page A could represent a weighted sum of the number of links to page A embedded in other pages as described in the Google technology above. Reader valuation score on page A could represent a weighted sum of each reader's time spent on page A. There can be different formulas used for weighting each reader's time spent. For example, a weighted sum could represent the number of readers whose time spent on page A has exceeded a threshold. In other weighting calculation, one reader's contribution to the reader valuation score on a page may be capped to limit the effect of each individual. Another reader weighting may also be considered where different weights may be given to the valuation scores of different readers based on the reader's credential. A reader's credential can be established in various ways, such as based on his or her profession, educational level, record of valuating top rated pages, etc. The final valuation score on page A can then be calculated as a weighted combination of writer valuation score and reader valuation score. A higher weight may be applied to writers, as writers are often experts in the subject and whose opinion is of higher value.

The associations between valuation scores and page links can be stored as a table where each row has a page link, a valuation score, and other information about the page. In such table, a page link can be uniquely indexed. Other information about a page can be added in a row. For example, “fingerprints” of the page can be stored in the row. Each fingerprint is a hash value of the page or a portion of the page. Fingerprints can be used to identify whether or not and how much the content of a page has changed even though the page link remains the same. If the content has changed almost entirely, the associated valuation score can be reset.

Means for Tracking Readers Time Spent

There can be different means for tracking reader's time spent on documents (pages). One preferred means is to have a software agent installed on the reader's computer. The software agent could be a plug-in to the web browser, or an independent program running in the computer in either the kernel or user layer, or it could be a built-in function in the programs that opens pages such as web browser or word processing program. The software agent can be installed as part of an agreement between the user and the search engine service provider. The agreement may enforce user privacy protection either by law or by technology in the software agent and search engine that reader valuation score may not comprise or reveal user identity. The software agent will track the user time spent on a document and send the time together with the page link to the search engine, which would update the valuation score in the public, private, and/or group category for the page link. Time normalization is preferably done in the search engine. One method for the software agent to determine the user time spent on a page is to find the program window (such as the web browser) displaying the page, and record the time durations of user operations on the window. User operations include any input of mouse movement, mouse clicks, keyboard strokes, or other input through other user controlled peripheral device. Time durations of user operations should exclude long idle time, for example, a time duration longer than 10 minutes in which no user inputs are received in the window may be excluded, while two consecutive mouse clicks with 5 minutes pause in between may be included. The computer operating system provides means to identify the window displaying a page, and to record user inputs from peripheral devices such as keyboard, mouse, and touch-sensitive screen in a given window.

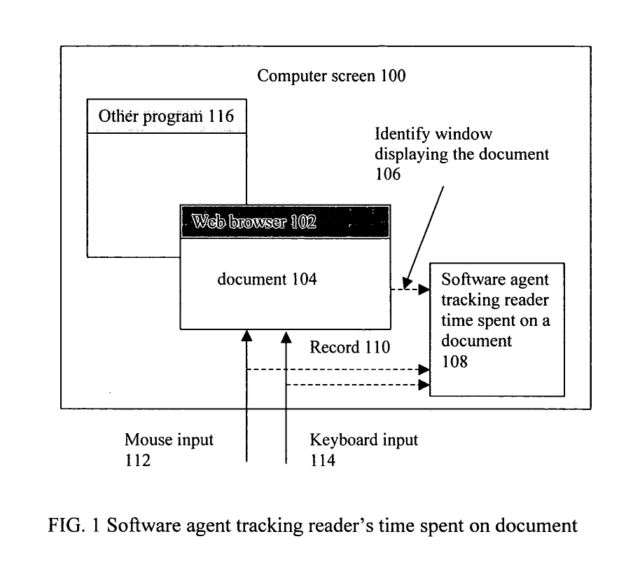

The above description of tracking reader's time spent on a document is illustrated in FIG. 1. Refer to FIG. 1, a computer screen 100 displays a front window of a web browser 102 and other program 116. The web browser 102 displays a document 104. The software agent 108 identifies the window displaying the document 104 in step 106, and records mouse input 112 and keyboard input 114 in step 110 to derive the reader's time spent on the document 104.

The present invention can be applied in Internet search engine. It can also be applied in search of local computer. When applied in Internet search engine, the search engine and the software agent are in different computers and the data are sent over computer networks. Preferably, the search engine should authenticate the software agent to prevent manipulated time sent automatically by unauthorized software agent. The software agent authentication can be part of the process of checking and authenticating user account when the user logons the search engine, or it can be done between the software agent and the search engine independently.

When the present invention is applied in local computer search, the search engine and the software agent are in the same computer. When used for local search, a private category of valuation scores is established as described in one of the embodiments above, which can help user quickly identify documents that the user has previously spent significant time on. The present invention can also be applied in Internet search and local search simultaneously, where the software agent may interact with the Internet search engine and the local search engine simultaneously.

To provide further user privacy protection, the software agent could offer an option for the user to stop tracking or reporting reader time spent at anytime for any page.

In another embodiment, when using private category of valuation scores either for Internet or local search, the software agent may work independently of the search engine. The software agent keeps track of reader's time spent on documents and locally maintains a private category of reader valuation scores for page links. When a list of page links is returned from a search engine, the software agent searches in the private category for reader valuation scores for each page link and re-sorts the list accordingly. If a page link finds no reader valuation score in the private category, a zero reader valuation score is assigned, and the order of those links with zero valuation scores will not be altered. As described before, using private category of reader valuation scores helps user quickly identify documents that the user has previously spent significant time on. This embodiment has benefit of working with one or more search engines simultaneously. And it is also easier to implement, as a client software package can be installed in user computers independently of search engines.

System Operation Description

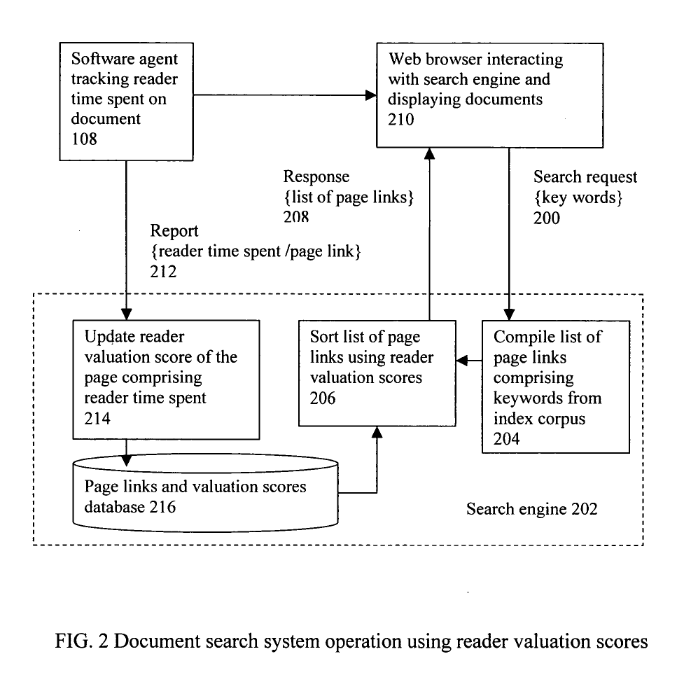

FIG. 2 illustrates the system operations comprising document sorting and valuating of the present invention. System operations of other embodiments of the present invention should become obvious for those skilled in the art following the description below.

Refer to FIG. 2, a web browser 210 sends keywords entered by a reader to the search engine 202 in step 200. The search engine 202 compiles a list of page links comprising the keywords from index corpus in step 204, then sorts the list of page links using reader valuation scores stored in database 216 in step 206, and sends the list of page links to the web browser 210 in step 208. The web browser 210 displays the list of page links, and following a click on a page link by the reader, the full document of the page link. When the web browser 210 displays the full document, the software agent 108 starts tracking the reader's time spent on the document. And when the reader stops reading the document, the software agent 108 reports the reader's time spent together with the page link to the search engine 202 in step 212. The search engine 202 then updates a reader valuation score of the page comprising the reader's time spent in step 214 and saves the result in a database 216.

The present invention may be embodied in other specific forms without departing from the spirit or central characteristics thereof. The present embodiments are therefore to be considered in all respects as illustrative and not restrictive.

1. A method for valuating documents, comprising steps of:
tracking reader time spent by a reader on a document;
updating a reader valuation score of said document comprising said time spent;

2. The method of claim 1, wherein said updating a reader valuation score comprising step of normalizing said time on the length of said document.

3. The method of claim 2, wherein said updating a reader valuation score comprising step of reducing said normalized time to a value such that total normalized time including all previous normalized time spent by said reader on said document not exceeding a preset value.

4. The method of claim 3, wherein said updating a reader valuation score comprising step of adding the reduced normalized time to said reader valuation score.

5. The method of claim 1, wherein said tracking time spent by a reader on a document comprising steps of:
identifying the window displaying said document on a computer;
recording time duration of user operation on said window.

6. The method of claim 5, wherein said recording time duration of user operation on said window comprising step of recording time duration when said window receiving input from any user controlled peripheral device connecting to said computer including any of the following devices:
a keyboard;
a mouse;
a touch sensitive device.

7. The method of claim 1 comprising step of identifying a group category associated with said reader, and wherein said reader valuation score being maintained for said group, said group being identified with any of the following attributes:
profession;
education level;
age range;
sex;
nationality.

8. The method of claim 1 comprising step of identifying a private account associated with said reader, and wherein said reader valuation score being maintained for said private account.

9. The method of claim 1, wherein said length of said document being the number of words in said document.

10. The method of claim 1, wherein said length of said document being the sum of the following two values:
number of words comprised in said document;
a scaling number multiplying the number of figures comprised in said document.

11. The method of claim 1 comprising step of authenticating means of tracking time spent by said reader on said document.

12. A system for valuating documents, comprising following modules:
a time record module for tracking time spent by a reader on a document;
a valuation update module for updating a reader valuation score of said document comprising said time spent.

13. The system of claim 12, wherein said valuation update module comprising a time normalization module for normalizing said time on the length of said document.

14. The system of claim 13, wherein said valuation update module comprising a time limiting module for reducing said normalized time to a value such that total normalized time including all previous normalized time spent by said reader on said document not exceeding a preset value.

15. The system of claim 12, wherein said time record module comprising:
a window identification module for identifying the window displaying said document on a computer;
a user input recording module for recording time duration of user operation on said window, wherein said user operation comprising any input from any user controlled peripheral device connecting to said computer including any of following devices:
a keyboard;
a mouse;
a touch sensitive device.

16. The system of claim 12 comprising an account identification module for checking identity of said reader and retrieving account information of said reader.

17. The system of claim 16, wherein said account information comprising a group category associated with said reader, and wherein said reader valuation score comprising said time spent by said reader being maintained for said group, said group being identified with any of the following attribute:
profession;
education level;
age range;
sex;
nationality

18. The system of claim 16, wherein said reader valuation score comprising said time spent by said reader being maintained for said account.

19. The system of claim 12 comprising an authentication module for authenticating said time record module.

20. The system of claim 13 comprising a document length measurement module for measuring the length of a document as the sum of the following two values:
number of words in said document;
a scaling number multiplying the number of figures in said document.
